(19) United States
(12) Patent Application Publication
(10) Pub. No.: US 2021/0013809 A1
(43) Pub. Date: Jan. 14, 2021

(54) PRIMARY CONTROLLER APPLIED TO A PRIMARY SIDE OF A POWER CONVERTER AND OPERATIONAL METHOD THEREOF

(71) Applicant: Leadtrend Technology Corp., Hsinchu County (TW)

(72) Inventor: Chi-Pin Chen, Hsinchu County (TW)

(21) Appl. No.: 16/737,923

(22) Filed: Jan. 9, 2020

(30) Foreign Application Priority Data
Jul. 12, 2019 (TW) 108124693

(51) Int. Cl. H02M 3/335; H02M 3/338

(52) U.S. Cl. CPC H02M 3/33507; H02M 3/3385; H02M 3/3381

(57) ABSTRACT

A primary controller applied to a primary side of a power converter includes a current compensation circuit and a compensation voltage generation circuit. The current compensation circuit is used for generating a compensation current to a sensing resistor of the primary side according to a direct voltage and an auxiliary voltage, wherein the auxiliary voltage corresponds to an output voltage of a secondary side of the power converter, and the compensation current changes a peak voltage of the primary side. The compensation voltage generation circuit is used for generating a compensation voltage according to a reference current, a discharge time of the secondary side, and a peak current, wherein the reference current is changed with the output voltage. The compensation current and the reference current are used for making an output current of the secondary side of the power converter not be changed with the output voltage.

### BACKGROUND OF THE INVENTION

### 1. Field of the Invention

The present invention relates to a primary controller applied to a primary side of a power converter and an operational method thereof, and particularly to the primary controller and the operational method thereof that can make an output current of a secondary side of the power converter not be changed with an output voltage of the secondary side of the power converter.

### 2. Description of the Prior Art

In the prior art, a designer of a constant current power converter can utilize a primary controller applied to a primary side of the power converter to control turning-on and turning-off of the power converter. The primary controller utilizes a peak current corresponding to a peak voltage of the primary side of the power converter, a discharge time of a secondary side of the power converter, and a reference current to determine a compensation voltage of a compensation pin of the power converter, and then controls turning-on and turning-off of a power switch of the power converter according to the compensation voltage, wherein the compensation voltage corresponds to an output voltage of the secondary side of the power converter, and the primary controller utilizes the above-mentioned negative feedback mechanism to make an output current of the secondary side of the power converter be a constant current. In addition, one of ordinary skill in the art should know the output current corresponds to a turn ratio of a primary side inductor of the power converter to a secondary side inductor of the power converter, the peak current, a sensing resistor of the primary side of the power converter, the discharge time, and a switching period of the power switch. Ideally, the output current is not changed with the output voltage, but because the peak current, the discharge time, and the switching period of the power switch are changed with the output voltage, the output current is still changed with the output voltage in fact. Therefore, how to make the output current not be changed with the output voltage becomes an important issue of the designer of the power converter.

### SUMMARY OF THE INVENTION

An embodiment of the present invention provides a primary controller applied to a primary side of a power converter. The primary controller includes a current compensation circuit and a compensation voltage generation circuit. The current compensation circuit is used for generating a compensation current to a sensing resistor of the primary side according to a direct voltage and an auxiliary voltage, wherein the auxiliary voltage corresponds to an output voltage of a secondary side of the power converter, and the compensation current is used for changing a peak voltage of the primary side. The compensation voltage generation circuit is coupled to the current compensation circuit for generating a compensation voltage according to a reference current, a discharge time of the secondary side, and a peak current, wherein the reference current is changed with the output voltage of the secondary side of the power converter. The compensation current and the reference current are used for making an output current of the secondary side of the power converter not be changed with the output voltage of the secondary side of the power converter.

Another embodiment of the present invention provides an operational method of a primary controller applied to a primary side of a power converter, wherein the primary controller includes a current compensation circuit, a compensation voltage generation circuit, and a gate control signal generation circuit. The operational method includes the current compensation circuit generating a compensation current to a sensing resistor of the primary side according to a direct voltage and an auxiliary voltage, wherein the auxiliary voltage corresponds to an output voltage of a secondary side of the power converter, and the compensation current is used for changing a peak voltage of the primary side; the compensation voltage generation circuit generating a compensation voltage according to a reference current, a discharge time of the secondary side, and a peak current, wherein the reference current is changed with the output voltage of the secondary side of the power converter; and the gate control signal generation circuit generating a gate control signal to a power switch of the primary side of the power converter according to the compensation voltage, wherein the gate control signal is used for controlling turning-on and turning-off of the power switch. The compensation current and the reference current are used for making an output current of the secondary side of the power converter not be changed with the output voltage of the secondary side of the power converter.

The present invention provides a primary controller applied to a primary side of a power converter and an operational method thereof. The primary controller and the operational method utilize a compensation current generated by a current compensation circuit of the primary controller inversely changed with an output voltage of a secondary side of the power converter and a reference current generated by a reference current source of the primary controller positively changed with the output voltage to make an output current of the secondary side of the power converter not be changed with the output voltage. Therefore, compared to the prior art, because both the compensation current and the reference current correspond to the output voltage, the present invention can effectively eliminates an influence of the output voltage on the output current.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a primary controller applied to a primary side of a power converter according to a first embodiment of the present invention.

FIG. 2 is a diagram illustrating a compensation voltage generation circuit of the primary controller for generating a compensation voltage.

FIG. 3 is a diagram illustrating actual values of the sensing voltage and ideal values of the sensing voltage.

FIG. 4 is a diagram illustrating a relationship between the output current of the secondary side of the power converter and the input voltage of the primary side of the power converter.

FIG. 5 is a diagram illustrating the current compensation circuit.

FIG. 6 is a diagram illustrating a relationship between the compensation current and the auxiliary voltage.

FIG. 7 is a diagram illustrating relationships between the output current, the output voltage, and the input voltage.

FIG. 8 is a diagram illustrating the reference current source.

FIG. 9 is a diagram illustrating relationships between the output current, the output voltage, and the input voltage.

FIG. 10 is a flowchart illustrating an operational method of a primary controller applied to a primary side of a power converter according to a second embodiment of the present invention.

### DETAILED DESCRIPTION

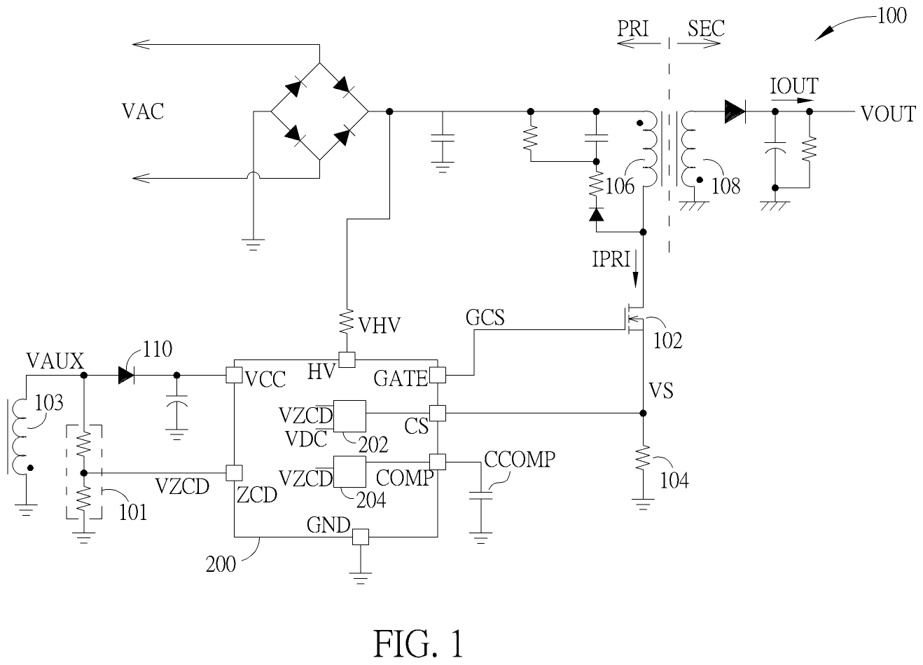

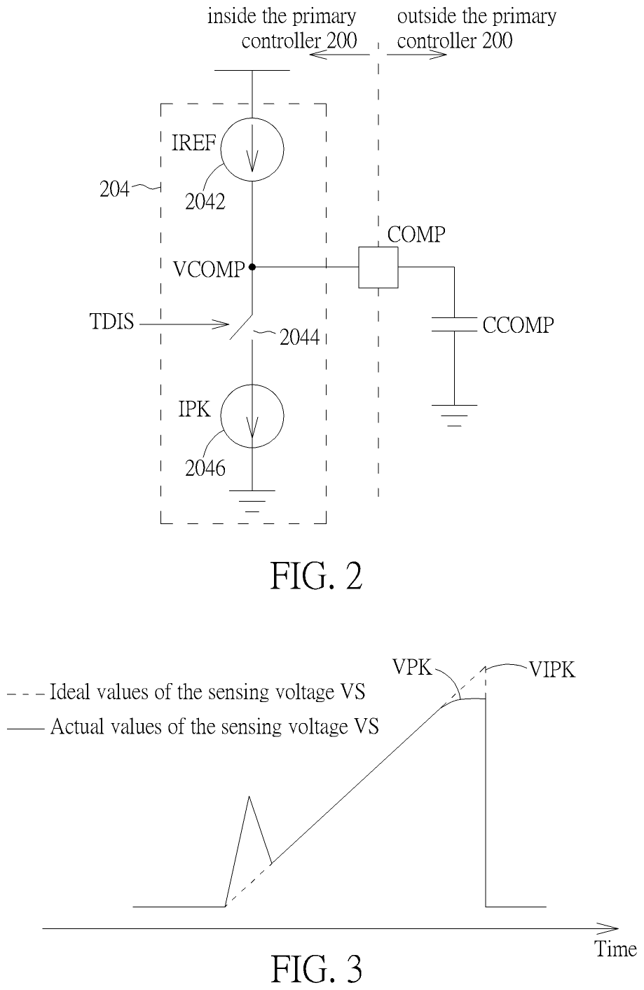

Please refer to FIGS. 1, 2. FIG. 1 is a diagram illustrating a primary controller 200 applied to a primary side PRI of a power converter 100 according to a first embodiment of the present invention, and FIG. 2 is a diagram illustrating a compensation voltage generation circuit 204 of the primary controller 200 for generating a compensation voltage VCOMP, wherein the primary controller 200 includes a current compensation circuit 202 and the compensation voltage generation circuit 204, the power converter 100 is a flyback power converter, and the current compensation circuit 202 is coupled to an auxiliary winding 103 of the primary side PRI of the power converter 100 through a voltage divider 101. As shown in FIG. 2, the compensation voltage generation circuit 204 utilizes a peak current IPK, a discharge time TDIS of a secondary side SEC of the power converter 100, and a reference current IREF to determine the compensation voltage VCOMP of a pin COMP of the primary controller 200. In addition, as shown in FIG. 2, the compensation voltage generation circuit 204 includes a reference current source 2042, a switch 2044, and a peak current source 2046, wherein the reference current source 2042 is used for providing the reference current IREF, the switch 2044 is turned on according to the discharge time TDIS, the peak current source 2046 is used for providing the peak current IPK, and coupling relationships between the reference current source 2042, the switch 2044, and the peak current source 2046 can be referred to FIG. 2, so further description thereof is omitted for simplicity. After the compensation voltage VCOMP is generated, a gate control signal generation circuit (not shown in FIGS. 1, 2) of the power converter 100 can generate a gate control signal GCS to control turning-on and turning-off of a power switch 102 of the power converter 100 according to the compensation voltage VCOMP, wherein the gate control signal GCS is transmitted to the power switch 102 through a pin GATE of the primary controller 200, and the peak current IPK can be determined according to equation (1):

$$IPK = \frac{VPK}{RS} \times K \qquad ( 1 )$$

As shown in equation (1), VPK is a peak voltage of the primary side PRI of the power converter 100, RS is a resistance of a sensing resistor 104 of the primary side PRI of the power converter 100, and K is a constant value.

In addition, as shown in FIG. 2, when the compensation voltage VCOMP is not changed, equation (2) can be held according to conservation of charge of a compensation capacitor CCOMP coupled to the pin COMP:

IREF×TS=IPK×TDIS (2)

As shown in equation (2), TS is a switching period of the power switch 102. In addition, one of ordinary skill in the art should also know an output current IOUT of the secondary side SEC of the power converter 100 can be determined by equation (3):

$$IOUT = \frac{1}{2} \times \frac{NP}{NS} \times \frac{VPK}{RS} \times \frac{TDIS}{TS} \qquad ( 3 )$$

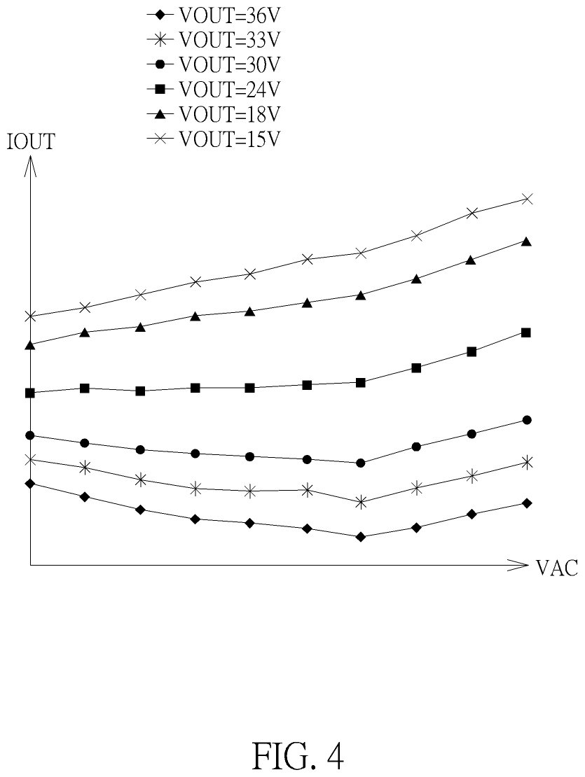

As shown in equation (3), NP is a number of turns of a primary side winding 106 of the primary side PRI of the power converter 100, and NS is a number of turns of a secondary side winding 108 of the secondary side SEC of the power converter 100. Because a sensing voltage VS of the sensing resistor 104 is determined by the sensing resistor 104, a turning-on time TON of the power switch 102, and a current IPRI flowing through the primary side PRI of the power converter 100, the peak voltage VPK of the sensing voltage VS can be determined by the sensing voltage VS and the turning-on time TON of the power switch 102 ideally. However, because the sensing voltage VS is not ideal (wherein actual values of the sensing voltage VS can be referred to a solid line shown in FIG. 3 and ideal values of the sensing voltage VS can be referred to a dotted line shown in FIG. 3), the peak voltage VPK is not equal to an ideal peak voltage VIPK of the sensing voltage VS. That is to say, an error exists between the peak voltage VPK and the ideal peak voltage VIPK. In addition, in fact, the discharge time TDIS of the secondary side SEC of the power converter 100 is also not ideal. That is to say, because a beginning and an end of the discharge time TDIS cannot be determined accurately, the discharge time TDIS is not equal to an ideal discharge time, resulting in an error existing between the discharge time TDIS and the ideal discharge time. Therefore, because both of the peak voltage VPK and the discharge time TDIS are inaccurate, in fact, the output current IOUT will be changed with the output voltage VOUT of the secondary side SEC of the power converter 100 (shown in FIG. 4), wherein a vertical axis of FIG. 4 represents the output current IOUT, and a vertical axis of FIG. 4 represents an input voltage VAC of the primary side PRI of the power converter 100.

Because the compensation voltage VCOMP corresponds to the output voltage VOUT, and the gate control signal generation circuit can generate the gate control signal GCS to control the turning-on time TON of the power switch 102 of the power converter 100 according to the compensation voltage VCOMP, the turning-on time TON of the power switch 102 corresponds to the output voltage VOUT. Because the turning-on time TON of the power switch 102 corresponds to the output voltage VOUT, and the peak voltage VPK can be determined by the sensing voltage VS and the turning-on time TON of the power switch 102, the peak voltage VPK also corresponds to the output voltage VOUT. In addition, because the discharge time TDIS of the secondary side SEC of the power converter 100 corresponds to the turning-on time TON of the power switch 102, the discharge time TDIS also corresponds to the output voltage VOUT. Therefore, because both of the peak voltage VPK and the discharge time TDIS correspond to the output voltage VOUT, as shown in FIG. 5, the current compensation circuit 202 can generate a compensation current ICC to the sensing resistor 104 according to a direct voltage VDC and an auxiliary voltage VZCD, wherein the current compensation circuit 202 receives the auxiliary voltage VZCD through a pin ZCD of the primary controller 200, the compensation current ICC flows into the sensing resistor 104 through a pin CS of the primary controller 200 during the turning-on time TON of the power switch 102, and the direct voltage VDC corresponds to a voltage VHV of a pin HV of the primary controller 200 (e.g. the direct voltage VDC is generated by dividing the voltage VHV) . In addition, because the voltage VHV corresponds to the input voltage VAC, the direct voltage VDC also corresponds to the input voltage VAC. In addition, as shown in FIG. 1, because the auxiliary voltage VZCD corresponds to a voltage VAUX generated by the auxiliary winding 103, the auxiliary voltage VZCD also corresponds to the output voltage VOUT. In addition, as shown in FIG. 1, the primary controller 200 receives the voltage VAUX through a pin VCC and a diode 110, and generates an operation voltage within the primary controller 200 according to the voltage VAUX. In addition, as shown in FIG. 1, the primary controller 200 is grounded through a pin GND.

As shown in FIG. 5, a digital-to-analog converter (DAC) 2022 of the current compensation circuit 202 can convert the auxiliary voltage VZCD into digital signals DS1, DS2. But, the present invention is not limited to the digital-to-analog converter 2022 being a 2-bit digital-to-analog converter. As shown in FIG. 5, an operational amplifier 20242, an N-type metal-oxide-semiconductor transistor 20244, and a resistor 20246 of a compensation current generation unit 2024 can determine a current IS according to the direct voltage VDC. Then, a first current mirror of the compensation current generation unit 2024 composed of P-type metal-oxide-semiconductor transistors 20248, 20250, 20252 can generate the compensation current ICC to the sensing resistor 104 according to the current IS and the digital signals DS1, DS2. In addition, coupling relationships between the operational amplifier 20242, the N-type metal-oxide-semiconductor transistor 20244, the resistor 20246, and the P-type metal-oxide-semiconductor transistors 20248, 20250, 20252 can be referred to FIG. 5, so further description thereof is omitted for simplicity. In addition, because as shown in FIG. 5, the current compensation circuit 202 generates the compensation current ICC according to the direct voltage VDC and the auxiliary voltage VZCD, the compensation current ICC simultaneously corresponds to the input voltage VAC and the output voltage VOUT (because the direct voltage VDC corresponds to the input voltage VAC and the auxiliary voltage VZCD corresponds to the output voltage VOUT). In addition, as shown in FIG. 1, because the compensation current ICC flows into the sensing resistor 104 through the pin CS of the primary controller 200, the compensation current ICC can change the peak current IPK of the primary side PRI of the power converter 100, wherein because the compensation current ICC simultaneously corresponds to the input voltage VAC and the output voltage VOUT, the peak current IPK also simultaneously corresponds to the input voltage VAC and the output voltage VOUT.

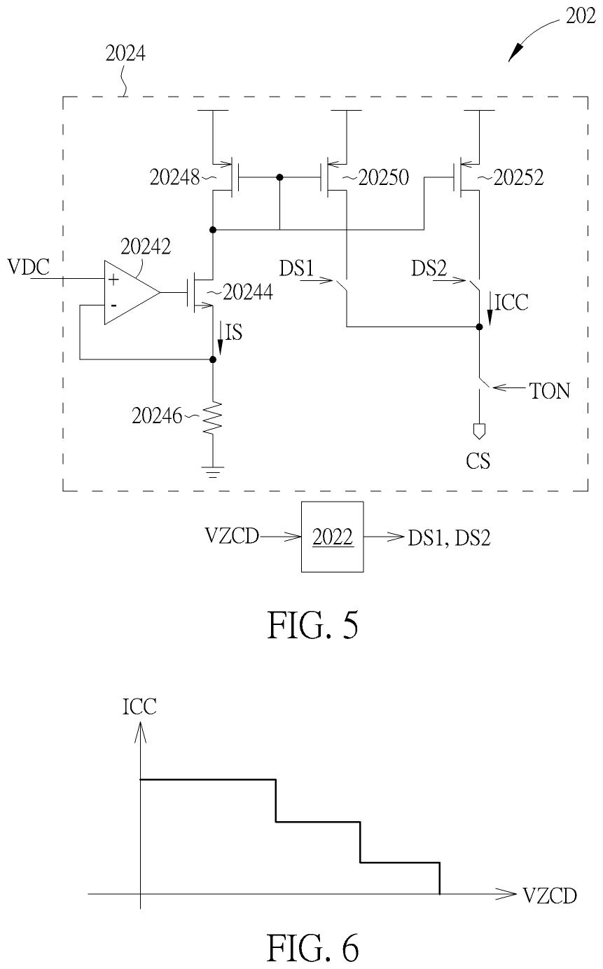

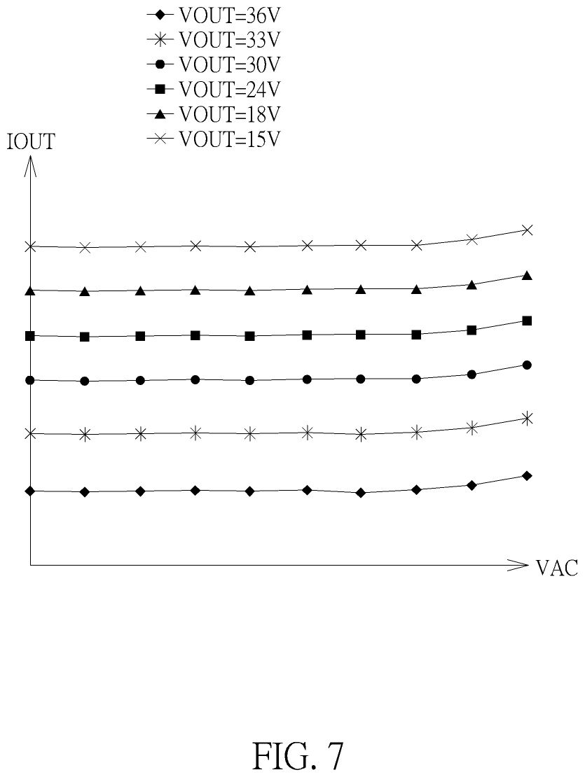

In addition, because when the output voltage VOUT is greater, the turning-on time TON of the power switch 102 is also greater, meanwhile an influence caused by an error of the turning-on time TON is smaller. Therefore, as shown in FIG. 6, when the output voltage VOUT is greater (that is, the auxiliary voltage VZCD is greater), the compensation current ICC is smaller. That is to say, the compensation current ICC is reduced with increase of the output voltage VOUT. In addition, the present invention is not limited to a structure of the current compensation circuit 202 shown in FIG. 5. That is to say, any current compensation circuit that can make the compensation current ICC be reduced with increase of the output voltage VOUT falls within the scope of the present invention. In addition, the present invention is not limited to the compensation current generation unit 2024 utilizing a digital method shown in FIG. 6 to generate the compensation current ICC. That is to say, in another embodiment of the present invention, the compensation current generation unit 2024 can utilize an analog method to generate the compensation current ICC. In addition, after the compensation current generation unit 2024 generates the compensation current ICC to the sensing resistor 104, relationships between the output current IOUT, the output voltage VOUT, and the input voltage VAC can be referred to FIG. 7. As shown in FIG. 7, although slops of curves corresponding to the different output voltage VOUT are similar, offsets exist between the curves, wherein the offsets are caused by a gain of a negative feedback loop of a constant current control of the primary controller 200 being smaller.

Equation (3) is held based on the gain of the negative feedback loop of the constant current control being large enough, so when the gain of the negative feedback loop of the constant current control are smaller, equation (3) needs to be introduced a fact corresponding to the gain of the negative feedback loop to generate equation (4):

$$IOUT = \frac{GCC}{1 + GCC} \times \frac{1}{2} \times \frac{NP}{NS} \times \frac{VPK}{RS} \times \frac{TDIS}{TS} \qquad ( 4 )$$

As shown in equation (4), GCC is the gain of the negative feedback loop. In addition, substituting equation (1) and equation (2) into equation (4) can generate equation (5):

$$IOUT = \frac{GCC}{1 + GCC} \times \frac{1}{2} \times \frac{NP}{NS} \times \frac{IREF}{K} \times \frac{1}{RS} \qquad ( 5 )$$

As shown in equation (5), when the gain GCC of the negative feedback loop is smaller and the output voltage VOUT is changed, the output current IOUT will be changed with the output voltage VOUT, so influence on the output current IOUT caused by the gain GCC of the negative feedback loop can be eliminated by adjusting the reference current IREF. In addition, as shown in equation (5), the output current IOUT positively correlates with the reference current IREF, so the reference current IREF provided by the reference current source 2042 needs to be changeable and be changed with the output voltage VOUT to eliminate the offsets existing between the curves.

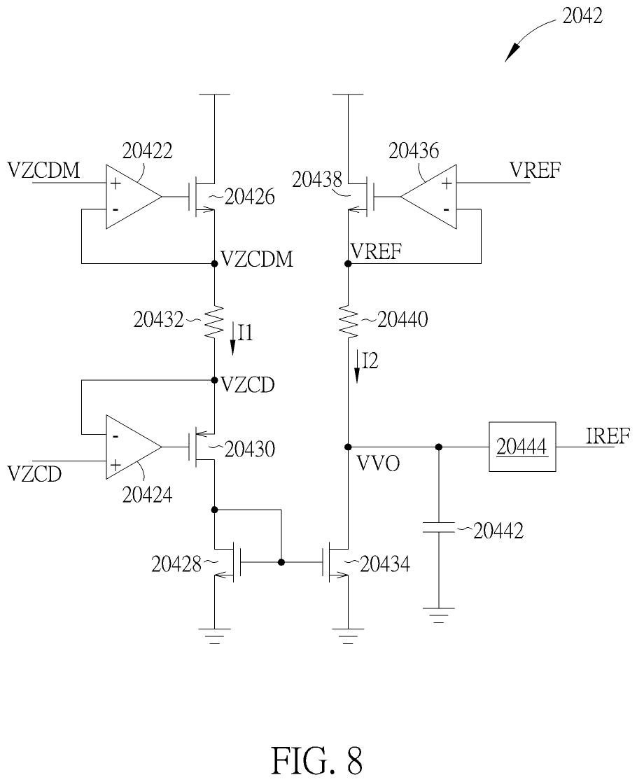

Please refer to FIG. 8. FIG. 8 is a diagram illustrating the reference current source 2042. As shown in FIG. 8, operational amplifiers 20422, 20424, N-type metal-oxide-semiconductor transistors 20426, 20428, a P-type metal-oxide-semiconductor transistor 20430, and a resistor 20432 of the reference current source 2042 can determine a first current I1 according to a constant voltage VZCDM and the auxiliary voltage VZCD. As shown in FIG. 8, the constant voltage VZCDM is set according to a maximum of an operational range of the output voltage VOUT, so the first current I1 is inversely changed with the auxiliary voltage VZCD. That is to say, the first current I1 is reduced with increase of the auxiliary voltage VZCD and the first current I1 is increased with decrease of the auxiliary voltage VZCD. Because the auxiliary voltage VZCD positively correlates with the output voltage VOUT, the first current I1 is also inversely changed with the output voltage VOUT. Then, a second current mirror composed of the N-type metal-oxide-semiconductor transistor 20428 and an N-type metal-oxide-semiconductor transistor 20434 of the reference current source 2042 can generate a second current 12 according to the first current I1, wherein a ratio of an aspect ratio of the N-type metal-oxide-semiconductor transistor 20434 to an aspect ratio of the N-type metal-oxide-semiconductor transistor 20428 and the first current I1 can determine the second current 12 through equation (6), wherein because the first current I1 is inversely changed with the output voltage VOUT, the second current 12 is also inversely changed with the output voltage VOUT:

$$I 2 = \frac{{( W / L )}_{20434}}{{( W / L )}_{20428}} \times I 1 \qquad ( 6 )$$

As shown in equation (6) , (W/L)₂₀₄₃₄ is the aspect ratio of the N-type metal-oxide-semiconductor transistor 20434, and (W/L)₂₀₄₂₈ is the aspect ratio of the N-type metal-oxide-semiconductor transistor 20428.

In addition, as shown in FIG. 8, the reference current source 2042 can utilize an operational amplifier 20436, an N-type metal-oxide-semiconductor transistor 20438, a resistor 20440, a reference voltage VREF, and the second current 12 to determine a voltage VVO through equation (7), wherein a capacitor 20442 is used for stabilizing the voltage VVO:

VVO=VREF−(R₂₀₄₄₀+I2) (7)

As shown in equation (7) , R₂₀₄₄₀ is a resistance of the resistor 20440, wherein because the second current 12 is inversely changed with the output voltage VOUT, when the output voltage VOUT is increased, the voltage VVO is increased with increase of the output voltage VOUT. That is to say, the voltage VVO is positively changed with the output voltage VOUT.

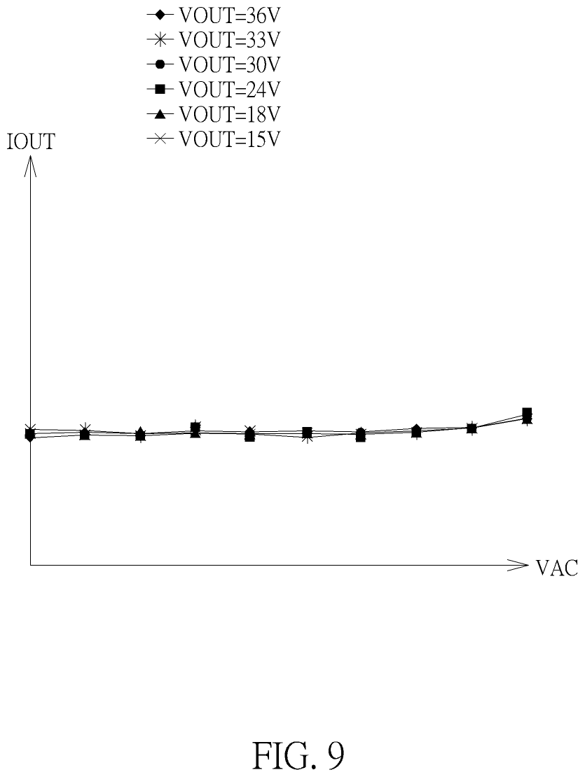

After the voltage VVO is generated, the reference current source 2042 can utilize a voltage-to-current converter 20444 to generate the reference current IREF. Because the voltage VVO is positively changed with the output voltage VOUT, the reference current IREF is also positively changed with the output voltage VOUT. Therefore, the offsets shown in FIG. 7 will be eliminated (as shown in FIG. 9) because of the reference current IREF being positively changed with the output voltage VOUT. Therefore, as shown in FIG. 9, the primary controller 200 can utilize the compensation current ICC generated by the current compensation circuit 202 and the reference current IREF generated by the reference current source 2042 to make the output current IOUT of the secondary side SEC of the power converter 100 not be changed with the output voltage VOUT. In addition, coupling relationships between the operational amplifiers 20422, 20424, 20436, the N-type metal-oxide-semiconductor transistors 20426, 20428, 20434, 20438, the P-type metal-oxide-semiconductor transistor 20430, the resistors 20432, 20440, the capacitor 20442, and the voltage-to-current converter 20444 can be referred to FIG. 8, so further description thereof is omitted for simplicity. In addition, the present invention is not limited to a structure of the reference current source 2042 shown in FIG. 8. That is to say, any reference current source that can make the reference current IREF be increased with increase of the output voltage VOUT falls within the scope of the present invention.

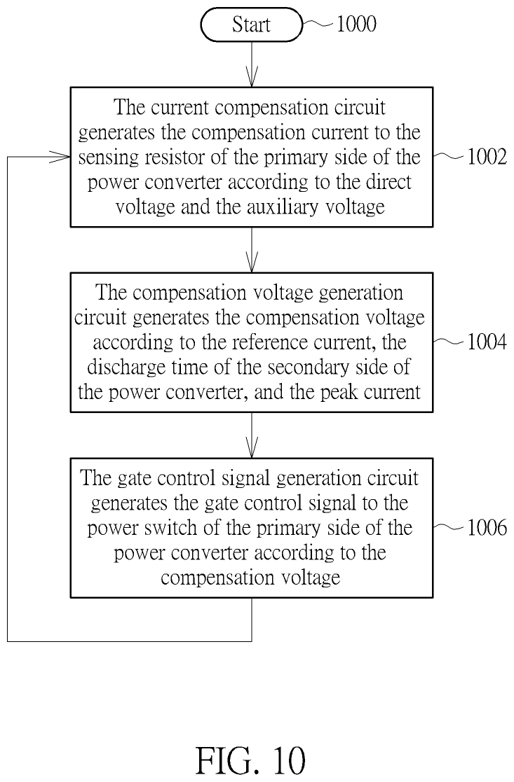

Please refer to FIGS. 1-10. FIG. 10 is a flowchart illustrating an operational method of a primary controller applied to a primary side of a power converter according to a second embodiment of the present invention. The operational method in FIG. 10 is illustrated using the power converter 100 and the primary controller 200 in FIG. 1, the compensation voltage generation circuit 204 in FIG. 2, the current compensation circuit 202 in FIG. 5, and the reference current source 2042 in FIG. 8. Detailed steps are as follows:

Step 1000: Start.

Step 1002: The current compensation circuit 202 generates the compensation current ICC to the sensing resistor 104 of the primary side PRI of the power converter 100 according to the direct voltage VDC and the auxiliary voltage VZCD.

Step 1004: The compensation voltage generation circuit 204 generates the compensation voltage VCOMP according to the reference current IREF, the discharge time TDIS of the secondary side SEC of the power converter 100, and the peak current IPK.

Step 1006: The gate control signal generation circuit generates the gate control signal GCS to the power switch 102 of the primary side PRI of the power converter 100 according to the compensation voltage VCOMP, go to Step 1002.

In Step 1002, as shown in FIG. 5, the current compensation circuit 202 can generate the compensation current ICC to the sensing resistor 104 according to the direct voltage VDC and the auxiliary voltage VZCD, wherein the compensation current ICC flows into the sensing resistor 104 through the pin CS of the primary controller 200 during the turning-on time TON of the power switch 102, and the direct voltage VDC corresponds to the voltage VHV of the pin HV of the primary controller 200. In addition, because the voltage VHV corresponds to the input voltage VAC, the direct voltage VDC also corresponds to the input voltage VAC. In addition, as shown in FIG. 1, because the auxiliary voltage VZCD corresponds to the voltage VAUX generated by the auxiliary winding 103, the auxiliary voltage VZCD also corresponds to the output voltage VOUT. As shown in FIG. 5, the digital-to-analog converter 2022 of the current compensation circuit 202 can convert the auxiliary voltage VZCD into the digital signals DS1, DS2. As shown in FIG. 5, the operational amplifier 20242, the N-type metal-oxide-semiconductor transistor 20244, and the resistor 20246 of the compensation current generation unit 2024 can determine the current IS according to the direct voltage VDC. Then, the first current mirror of the compensation current generation unit 2024 composed of the P-type metal-oxide-semiconductor transistors 20248, 20250, 20252 can generate the compensation current ICC to the sensing resistor 104 according to the current IS and the digital signals DS1, DS2. In addition, because as shown in FIG. 5, the current compensation circuit 202 generates the compensation current ICC according to the direct voltage VDC and the auxiliary voltage VZCD, the compensation current ICC simultaneously corresponds to the input voltage VAC and the output voltage VOUT (because the direct voltage VDC corresponds to the input voltage VAC and the auxiliary voltage VZCD corresponds to the output voltage VOUT). In addition, as shown in FIG. 1, because the compensation current ICC flows into the sensing resistor 104 through the pin CS of the primary controller 200, the compensation current ICC can change the peak current IPK of the primary side PRI of the power converter 100, wherein because the compensation current ICC simultaneously corresponds to the input voltage VAC and the output voltage VOUT, the peak current IPK also simultaneously corresponds to the input voltage VAC and the output voltage VOUT.

In addition, because when the output voltage VOUT is greater, he turning-on time TON of the power switch 102 is also greater, meanwhile the influence caused by the error of the turning-on time TON is smaller. Therefore, as shown in FIG. 6, when the output voltage VOUT is greater (that is, the auxiliary voltage VZCD is greater), the compensation current ICC is smaller. That is to say, the compensation current ICC is reduced with increase of the output voltage VOUT. In addition, after the compensation current generation unit 2024 generates the compensation current ICC to the sensing resistor 104, the relationships between the output current IOUT, the output voltage VOUT, and the input voltage VAC can be referred to FIG. 7. As shown in FIG. 7, although the slops of the curves corresponding to the different output voltage VOUT are similar, the offsets exist between the curves, wherein the offsets are caused by the gain of the negative feedback loop of the constant current control of the primary controller 200 being smaller.

In Step 1004, as shown in FIG. 8, the operational amplifiers 20422, 20424, the N-type metal-oxide-semiconductor transistors 20426, 20428, the P-type metal-oxide-semiconductor transistor 20430, and the resistor 20432 of the reference current source 2042 can determine the first current I1 according to the constant voltage VZCDM and the auxiliary voltage VZCD. As shown in FIG. 8, the constant voltage VZCDM is set according to the maximum of the operational range of the output voltage VOUT, so the first current I1 is inversely changed with the auxiliary voltage VZCD. That is to say, the first current I1 is reduced with increase of the auxiliary voltage VZCD and the first current I1 is increased with decrease of the auxiliary voltage VZCD. Because the auxiliary voltage VZCD positively correlates with the output voltage VOUT, the first current I1 is also inversely changed with the output voltage VOUT. Then, the second current mirror composed of the N-type metal-oxide-semiconductor transistor 20428 and the N-type metal-oxide-semiconductor transistor 20434 of the reference current source 2042 can generate the second current 12 according to the first current I1, wherein the ratio of the aspect ratio of the N-type metal-oxide-semiconductor transistor 20434 to the aspect ratio of the N-type metal-oxide-semiconductor transistor 20428 and the first current I1 can determine the second current I2 through equation (6). Because the first current I1 is inversely changed with the output voltage VOUT, the second current 12 is also inversely changed with the output voltage VOUT. In addition, as shown in FIG. 8, the reference current source 2042 can utilize the operational amplifier 20436, the N-type metal-oxide-semiconductor transistor 20438, the resistor 20440, the reference voltage VREF, and the second current 12 to determine the voltage VVO through equation (7). Because the second current 12 is inversely changed with the output voltage VOUT, when the output voltage VOUT is increased, the voltage VVO is increased with increase of the output voltage VOUT. That is to say, the voltage VVO is positively changed with the output voltage VOUT. Therefore, after the voltage VVO is generated, the reference current source 2042 can utilize the voltage-to-current converter 20444 to generate the reference current IREF. Because the voltage VVO is positively changed with the output voltage VOUT, the reference current IREF is also positively changed with the output voltage VOUT. Then, as shown in FIG. 2, the compensation voltage generation circuit 204 can utilize the peak current IPK, the discharge time TDIS of the secondary side SEC of the power converter 100, and the reference current IREF to determine the compensation voltage VCOMP of the pin COMP of the primary controller 200.

In Step 1006, after the compensation voltage VCOMP is generated, the gate control signal generation circuit (not shown in in FIGS. 1, 2) can generate the gate control signal GCS to control turning-on and turning-off of the power switch 102 of the power converter 100 according to the compensation voltage VCOMP.

Therefore, as shown in FIG. 9, after the compensation current ICC and the reference current IREF are generated, the primary controller 200 can make the output current IOUT not be changed with the output voltage VOUT.

To sum up, the power converter and the operational method utilize the compensation current generated by the current compensation circuit inversely changed with the output voltage and the reference current generated by the reference current source positively changed with the output voltage to make the output current not be changed with the output voltage. Therefore, compared to the prior art, because both the compensation current and the reference current correspond to the output voltage, the present invention can effectively eliminates an influence of the output voltage on the output current.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A primary controller applied to a primary side of a power converter, comprising:
a current compensation circuit for generating a compensation current to a sensing resistor of the primary side according to a direct voltage and an auxiliary voltage, wherein the auxiliary voltage corresponds to an output voltage of a secondary side of the power converter, and the compensation current is used for changing a peak voltage of the primary side; and
a compensation voltage generation circuit coupled to the current compensation circuit for generating a compensation voltage according to a reference current, a discharge time of the secondary side, and a peak current, wherein the reference current is changed with the output voltage of the secondary side of the power converter;
wherein the compensation current and the reference current are used for making an output current of the secondary side of the power converter not be changed with the output voltage of the secondary side of the power converter.

2. The primary controller of claim 1, wherein the power converter is a flyback power converter.

3. The primary controller of claim 1, wherein the compensation current is reduced with increase of the output voltage.

4. The primary controller of claim 1, wherein the reference current is increased with increase of the output voltage.

5. The primary controller of claim 1, wherein the output current corresponds to the discharge time of the secondary side of the power converter and the peak voltage.

6. The primary controller of claim 1, wherein the peak current corresponds to the peak voltage.

7. The primary controller of claim 1, wherein the discharge time of the secondary side of the power converter and the peak voltage are changed with the output voltage of the secondary side of the power converter.

8. The primary controller of claim 1, wherein the current compensation circuit is coupled to an auxiliary winding of the primary side of the power converter through a voltage divider.

9. The primary controller of claim 1, wherein the direct voltage corresponds to an input voltage of the primary side of the power converter.

10. The primary controller of claim 1, further comprising:
a gate control signal generation circuit for generating a gate control signal to a power switch of the primary side of the power converter according to the compensation voltage, wherein the gate control signal is used for controlling turning-on and turning-off of the power switch.

11. An operational method of a primary controller applied to a primary side of a power converter, wherein the primary controller comprises a current compensation circuit, a compensation voltage generation circuit, and a gate control signal generation circuit, the operational method comprising:
the current compensation circuit generating a compensation current to a sensing resistor of the primary side according to a direct voltage and an auxiliary voltage, wherein the auxiliary voltage corresponds to an output voltage of a secondary side of the power converter, and the compensation current is used for changing a peak voltage of the primary side;
the compensation voltage generation circuit generating a compensation voltage according to a reference current, a discharge time of the secondary side, and a peak current, wherein the reference current is changed with the output voltage of the secondary side of the power converter; and
the gate control signal generation circuit generating a gate control signal to a power switch of the primary side of the power converter according to the compensation voltage, wherein the gate control signal is used for controlling turning-on and turning-off of the power switch;
wherein the compensation current and the reference current are used for making an output current of the secondary side of the power converter not be changed with the output voltage of the secondary side of the power converter.

12. The operational method of claim 11, wherein the compensation current is reduced with increase of the output voltage.

13. The operational method of claim 11, wherein the reference current is increased with increase of the output voltage.

14. The operational method of claim 11, wherein the output current corresponds to the discharge time of the secondary side of the power converter and the peak voltage.

15. The operational method of claim 11, wherein the peak current corresponds to the peak voltage.

16. The operational method of claim 11, wherein the discharge time of the secondary side of the power converter and the peak voltage are changed with the output voltage of the secondary side of the power converter.

17. The operational method of claim 11, wherein the current compensation circuit is coupled to an auxiliary winding of the primary side of the power converter through a voltage divider.

18. The operational method of claim 11, wherein the direct voltage corresponds to an input voltage of the primary side of the power converter.
